(19) United States
(12) Patent Application Publication
(10) Pub. No.: US 2025/0289229 A1
(43) Pub. Date: Sep. 18, 2025

(54) Device and Method for Exhausting Aerosols

(71) Applicant: Canon Production Printing Holding B.V., Venlo (NL)

(72) Inventors: Albrecht Gerstner, Oberbergkirchen (DE); Pegah Pedramfar, München (DE); Thomas Szusdziara, Markt Schwaben (DE); Christoph Heininger, München (DE)

(21) Appl. No.: 19/079,942

(22) Filed: Mar. 14, 2025

(30) Foreign Application Priority Data
Mar. 15, 2024 (DE) 10 2024 107 424.8

(51) Int. Cl. B41J 2/17

(52) U.S. Cl. CPC B41J 2/1714

(57) ABSTRACT

An extraction device for an inkjet printing device is described that is designed to guide a printed recording medium along a transport direction through a constriction with a counter-traveling gas flow, in order to be able to exhaust aerosol before the constriction in the transport direction. The constriction is formed efficiently, flexibly, and precisely by a guiding unit that acts on the back side of the recording medium at the constriction.

### CROSS-REFERENCE TO RELATED APPLICATION

This application claims priority to German Patent Application No. 10 2024 107 424.8 filed Mar. 15, 2024, the disclosure of which is hereby incorporated by reference in its entirety.

### BACKGROUND OF THE INVENTION

### Field of the Invention

The invention relates to a device and a corresponding method for exhausting aerosols such as, for example, ink vapor.

### Description of Related Art

Inkjet printing devices can be used for printing to recording media such as, for example, paper. For this purpose, one or more nozzles are used in a print group of the printing device in order to fire ink droplets onto the recording medium, and thus to generate a desired print image on said recording medium. An inkjet printing device also typically comprises a drying unit in order to dry the recording medium after application of the print image, and in order to thereby fix the applied ink on the recording medium.

Upon printing to the recording medium, in the print group an aerosol with ink particles can be created which can be transported into the drying unit and may lead to fouling there. The aerosol with ink particles is also referred to as an ink vapor in this document.

### SUMMARY OF THE INVENTION

The present document deals with the technical object of efficiently and reliably reducing or avoiding fouling produced by an aerosol. The object is respectively achieved by the features of the independent device as described herein and by the features of the independent method as described herein.

According to an aspect of the invention, an extraction device to exhaust aerosols, in particular ink vapor, in an inkjet printing device is described, wherein the printing device has a print group for printing to a front side of a recording medium, in particular a recording medium in the form of a belt, that is moved through the print group along a transport direction. The extraction device comprises a mechanical barrier and a guiding unit, in particular a roller, that are designed to together form a constriction above the front side of the recording medium directed past the mechanical barrier, said front side being printed to in the print group, wherein the guiding unit is designed to act on the back side of the recording medium at the constriction. The guiding unit can thereby preferably be cylindrically formed across the entire width of the print region. Furthermore, the extraction device comprises a blower that is designed to effect a gas flow traveling counter to the transport direction in the constriction above the printed front side of the recording medium. The extraction device also comprises an extraction unit that is configured to exhaust aerosol, in particular ink vapor, from the printed front side of the recording medium in an extraction region that is arranged before the constriction with respect to the transport direction. For this purpose the extraction device can be arranged before the constriction, in particular above the extraction region.

According to a further aspect, a method is described for exhausting aerosol, in particular ink vapor, in an inkjet printing device, wherein the printing device has a print group for printing to a front side of a recording medium that is moved through the print group along a transport direction. The method comprises guiding the recording medium along the transport direction, through a mechanical constriction arranged above the front side of the recording medium, wherein the constriction is formed by a guiding unit that acts on the front side of the recording medium at the constriction. The method also comprises producing a gas flow that, at the constriction, travels counter to the transport direction above the printed front side of the recording medium. Moreover, the method comprises the exhausting of aerosol, in particular ink vapor, from the printed front side of the recording medium in an extraction region that is arranged before the constriction with respect to the transport direction.

### BRIEF DESCRIPTION OF THE DRAWINGS

In the following, exemplary embodiments of the invention are described in detail using the schematic drawings. Thereby shown are:

FIG. 1a a block diagram of an example of an inkjet printing device having a drying or fixing unit;

FIG. 1b a block diagram of an example of a drying unit for an inkjet printing device;

FIG. 1c an example of an inkjet printing device in a side view;

FIG. 2a an example of an extraction device for an inkjet printing device;

FIG. 2b a further example of an extraction device for an inkjet printing device;

FIG. 3a an example of an extraction device having a (deflection) roller at the constriction of the extraction device;

FIGS. 3b and 3c examples of arrangements of a filter unit within the housing of the extraction device; and

FIG. 4 a workflow diagram of an example of a method for exhausting aerosol in an inkjet printing device.

The non-limiting embodiments of the present invention will be described with reference to the accompanying drawings. Elements, features and components that are identical, functionally identical and have the same effect are, insofar as is not stated otherwise, respectively provided with the same reference character.

### DESCRIPTION OF THE INVENTION

In the following description, numerous specific details are set forth in order to provide a thorough understanding of the embodiments of the present invention. However, it will be apparent to those skilled in the art that the embodiments, including structures, systems, and methods, may be practiced without these specific details. Well-known methods, procedures, components, and circuitry have not been described in detail to avoid unnecessarily obscuring embodiments of the invention. The connections shown in the figures between functional units or other elements can also be implemented as indirect connections, wherein a connection can be wireless or wired. Functional units can be implemented as hardware, software or a combination of hardware and software.

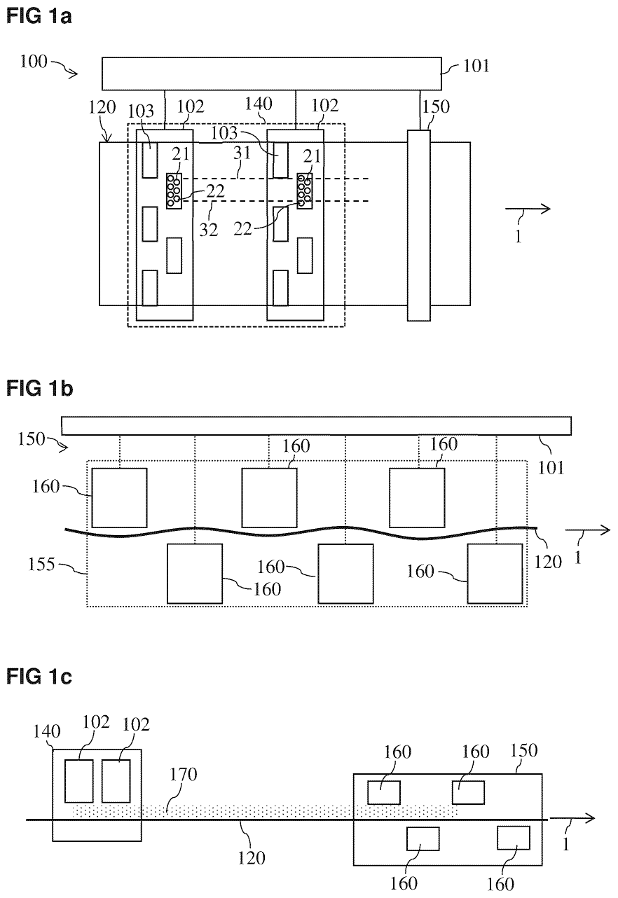

The printing device 100 depicted in FIG. 1a is designed for printing to a recording medium 120 in the form of a sheet or page or plate or belt. The recording medium 120 can be produced from paper, paperboard, cardboard, metal, plastic, textiles, a combination thereof, and/or other materials that are suitable and can be printed to. The recording medium 120 is guided through the print group 140 of the printing device 100 along the transport direction 1, represented by an arrow.

In the depicted example, the print group 140 of the printing device 100 comprises two print bars 102, wherein each print bar 102 can be used for printing with ink of a defined color, for example black, cyan, magenta, and/or yellow, and MICR ink if applicable. Different print bars 102 can be used for printing with respective different inks. Furthermore, the printing device 100 comprises at least one fixing or drying unit 150 that is configured to fix a print image printed onto the recording medium 120.

A print bar 102 can comprise one or more print heads 103, that are possibly arranged side by side in a plurality of rows in order to print the dots of different columns 31, 32 of a print image onto the recording medium 120. In the example presented in FIG. 1a, a print bar 102 comprises five print heads 103, wherein each print head 103 prints the dots of a group of columns 31, 32 of a print image onto the recording medium 120.

In the embodiment depicted in FIG. 1a, each print head 103 of the print group 140 comprises a plurality of nozzles 21, 22, wherein each nozzle 21, 22 is configured to fire or eject ink droplets onto the recording medium 120. For example, a print head 103 of the print group 140 can comprise multiple thousands of effectively utilized nozzles 21, 22 that are arranged along multiple rows transverse to the transport direction 1 of the recording medium 120, i.e. along the print width. Dots of a line of a print image can be printed onto the recording medium 120 transverse to the transport direction 1, i.e. along the width of the recording medium 120, by means of the nozzles 21, 22 of a print head 103 of the print group 140.

The printing device 100 also comprises a control unit 101, for example a driving hardware and/or a controller, that is configured to drive the actuators of the individual nozzles 21, 22 of the individual print heads 103 of the print group 140 in order to apply the print image onto the recording medium 120 depending on print data. The print data can respectively indicate for each nozzle 21, 22 (i.e. for each column 31, 32 of the print image), and for each line of the print image, whether an ink ejection should take place or not, and possibly what quantity of ink should be ejected.

The print group 140 of the printing device 100 thus comprises at least one print bar 102 having K nozzles 21, 22 that can be driven with a defined line timing in order to print a line running transverse to the transport direction 1 of the recording medium 120 onto the recording medium 120, said line having K pixels or K columns 31, 32 of a print image, for example with K>1000. In the shown example, the nozzles 21, 22 are installed in the printing device 100 so as to be immobile or fixed, and the recording medium 120 is directed past the stationary nozzles 21, 22 with a defined transport velocity.

As is presented above, the printing device 100 can comprise a drying unit 150 that is configured to dry the recording medium 120 after application of the ink via the one or more print bars 102, and therewith to fix the applied print image on the recording medium 120. The drying unit 150 shown in FIG. 1b comprises a plurality of drying modules 160 that are arranged on both sides of the recording medium 120 (typically in the form of a web) along a drying route, and that are respectively configured to blow a gaseous drying medium, typically heated air, onto the surface of the recording medium 120. The drying route with the drying modules 160 is thereby arranged in a housing 155 of the drying unit 150. By being blown upon with a gaseous drying medium, the print image on the recording medium 120 can be gently and reliably dried along the drying route of the drying unit 150.

During the printing operation, an ink vapor is typically created in the print group 140, said ink vapor comprising color pigments of the one or more different inks with which printing is taking place in the print group 140. The ink vapor 170 can be generally referred to as an aerosol. The ink vapor 170 can be entrained by the recording medium 120 along the transport direction 1, as is shown by way of example in FIG. 1c. In particular, the ink vapor 170 can be transported from the print group 140 into the following drying unit 150. The ink vapor 170 can then lead to fouling in the housing 155 of the drying unit 150, in particular at the one or more drying modules 160, wherein the quality of the drying of the recording medium 120 can be negatively affected by the fouling.

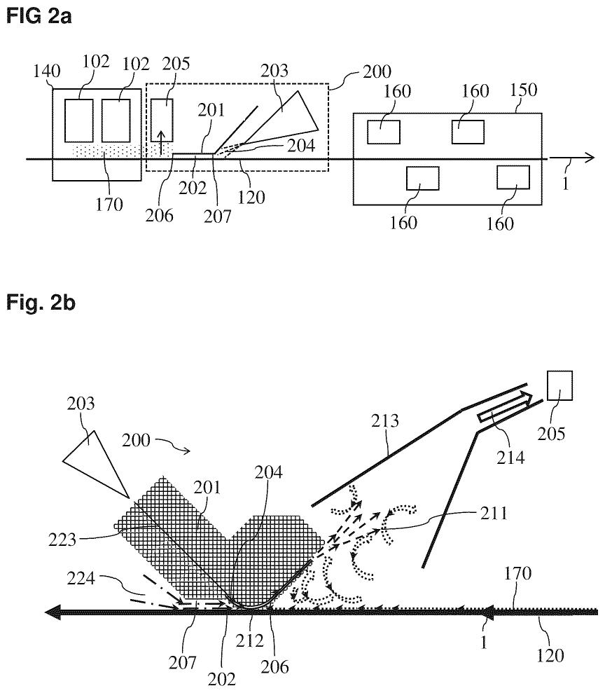

FIG. 2a shows an example of an extraction device 200 that, with respect to the transport direction 1, is arranged after the print group 140 and/or before the drying unit 150. The extraction device 200 comprises a mechanical barrier 201 that forms a mechanical constriction 202 through which the recording medium 120 is directed. The constriction 202 can have a height orthogonal to the surface of the recording medium 120, in particular orthogonal to the front side of the recording medium 120, that on the one hand is optimally small in order to let through only a smallest possible fraction of the ink vapor 170 entrained with the recording medium 120, but on the other hand is sufficiently large in order to avoid collisions with the recording medium 120. For example, the constriction 202 can have a height of between 0.1 mm and 10 mm, in particular between 1 and 6 mm.

The extraction device 200 also comprises a blower 203 that is designed to produce a gas flow 204 at the output 206 of the constriction 202, which gas flow 204 is opposite the transport direction 1. In this document, the gas flow 204 is also referred to as a blockade gas flow 204, since the gas flow 204 is designed to block the ink vapor 170 entrained by the recording medium 120 at the constriction 202. The blower 203 can be arranged after the constriction 202, in particular after the output 206 of the constriction 202.

Furthermore, the extraction device 200 comprises an extraction unit 205 that is configured to draw off the ink vapor 170 before the constriction 202. The extraction unit 205 can be arranged before the constriction 202, in particular before the entrance 206 of the constriction 202. The extraction unit 205 can also be separate from the mechanical barrier 201 forming the constriction 202. Via the blockade gas flow 204, it is effected that the ink vapor 170 essentially comes to a standstill or is moved counter to the transport direction 1 at the entrance 206 of the constriction 202 and/or before the constriction 202, so that the ink vapor 170 can be efficiently exhausted by an extraction unit 205 arranged before the constriction 202. As is presented in conjunction with FIG. 2b, the gas flow 204 produced by the blower 203 can be additionally strengthened by a bypass gas flow 224, whereby the blockade effect is further increased at the constriction 202 and/or at the entrance 206 to the constriction 202. The extraction unit 205 can act on a relatively large extraction opening, similar to a fume hood, in order to exhaust the ink vapor 170 over a large area.

Via the extraction device 200 shown in FIG. 2a, it can be reliably avoided that the ink vapor 170 fouls the subsequent drying unit 150.

The constriction 202 can have a length along the transport direction 1 that is less than 25 mm, in particular is markedly less than 25 mm. In particular, it can be advantageous if the length is less than 15 mm, more preferably is less than 10 mm, in particular is less than 5 mm. By providing a constriction 202 that has a defined maximum length in the transport direction 1, a turbulent air swirl and/or a laminar stall 211 of the boundary air layer can be generated at the surface of the recording medium 120, as is shown by way of example in FIG. 2b .

The mechanical barrier 201 preferably extends from the constriction 202 in the transport direction 1, as a ramp with increasing clearance. In other words, the mechanical barrier 201, together with the recording medium 120, can form a funnel starting from the exit 207 of the constriction 202, so that the cross section of the constriction 202 reduces in size with increasing distance from the exit 207 of the constriction 202. The constriction 202 can have a minimal cross section at an intermediate point 212 between the entrance 206 and the exit 207 of the constriction 202. For example, the mechanical barrier 201 can have a curved surface, for example a circular or elliptical surface, that is curved toward the constriction 202. The gas flow 204 is thus especially reliably directed from the blower 203 to the constriction 202, in particular to the intermediate point 212 of the constriction 202. As of the intermediate point 212 of the constriction 202, the cross section of the constriction 202 can increase in size again toward the entrance 206 of said constriction 202. It can thus be effected that the gas flow 204 of the blower 203 produces turbulent air swirls 211 before the entrance 206 of the constriction 202, with respect to the transport direction 1. In this way, air from the boundary air layer is entrained orthogonal to the transport direction 1, whereby the laminar flowing boundary air layer separates from the recording medium 120.

In the example shown in FIG. 2b, a gas flow 204 that acts directly on the constriction 202 is produced by the blower 203. For this purpose, the gas flow 204 can, for example, be directed from the blower 203 to the constriction 202 through a channel 223, wherein the channel 223 runs inside the mechanical barrier 201 by which the constriction 202 is formed. At the constriction 202, a Coandă effect can be produced [such] that the gas flow 204 is directed along the surface of the mechanical barrier 201, toward the entrance 206 of the constriction 202. An additional bypass gas flow 224 from the exit 27 of the constriction 202 to the entrance 206 of the constriction 202 can also be produced by the gas flow 204. An especially reliable blockading of ink vapor 170 can be produced at the constriction 202 by the additional bypass gas flow 224.

FIG. 2b shows a (funnel-shaped) housing 213 via which the gas mixture 214 that comprises the ink vapor 170 and the blockade gas flow 204, as well as the bypass gas flow 224, can be conveyed away from the entrance 206 of the constriction 202 using the extraction air flow produced by the extraction unit 205.

An ink vapor extraction 200 arranged between the one or more print heads 103 and the fixing 150 is thus described. The extraction 200 comprises a mechanical constriction 202 that is formed by a mechanical barrier 201, wherein the mechanical barrier 201 prevents at least a portion of the air contaminated with the ink vapor 170 from being transported by the recording medium 120 into the dryer 150. Typically, the smaller the gap formed by the constriction 202, and/or the higher the transport velocity of the recording medium 120, the more effective the constriction 202. The gap of the constriction 202 can thereby typically not be made arbitrarily small in order to take into account tolerances, a defined waviness of the recording medium 120, and/or adhesive joints of the recording medium 120.

To further increase the efficiency, a counter-traveling purge air flow 204 can be generated that moves counter to the running direction 1 of the recording medium 120. The purge air flow 204 can be generated by a blower 203, in particular by what is known as an air knife. Together with the bypass flow 224, an air flow 204, 224 is thereby generated that flows—counter to the transport direction 1—into the constriction 202, and possibly through the constriction 202. It can thus be reliably effected that the boundary air layer on the recording medium 120, which boundary air layer comprises the ink vapor 170, is blocked from flowing through the constriction 202. An escape of ink vapor 170 at the exit of the constriction 202 can thus be prevented by the purge air flow 204. In particular, via the purge air flow 204 it can be effected that the constriction 202 appears to be narrower for the boundary air layer, and an increased fraction of the boundary air layer is thereby stripped away or separated at the constriction 202. The effective efficiency of the constriction 202 can thus be increased.

The extraction device 200 is thus designed to stream air or a gas through a constriction 202 in a counter-direction in order to therewith “virtually” reduce the clearance or height of the constriction 202. The goal of separating (ink) particles and/or aerosols entrained with the recording medium 120 above the recording medium 120, and preventing them from being transported further with said recording medium 120, can thus be achieved.

The quantity of ink vapor 170 that is transported into the drying unit 150 can be reduced by the constriction 202 and by the purge air 204. In order to avoid fouling of the printing device 100 and/or of the environment of the printing device 100 with aerosols, the ink vapor 170 is exhausted through an extraction unit 205 that is arranged before the constriction 202. The extraction unit 205 can be flexibly arranged in spatial proximity to, or also relatively far removed from, the constriction 202. A particularly efficient and comprehensive extraction can thus be enabled before the constriction 202.

In that the constriction 202 is preferably executed to be very short, for example is designed with a length of 0.1 mm to 10 mm, and/or the mechanical barrier 201 terminates before the constriction 202, i.e. at the entrance 206 of the constriction 202, relative to the transport direction 1, air swirls and/or turbulences 211 are generated at the entrance 206 of the constriction 202 that lead to the boundary air layer with the aerosol 170 separating from the recording medium 120, and thus making it so that it can be better exhausted by the extraction unit 205.

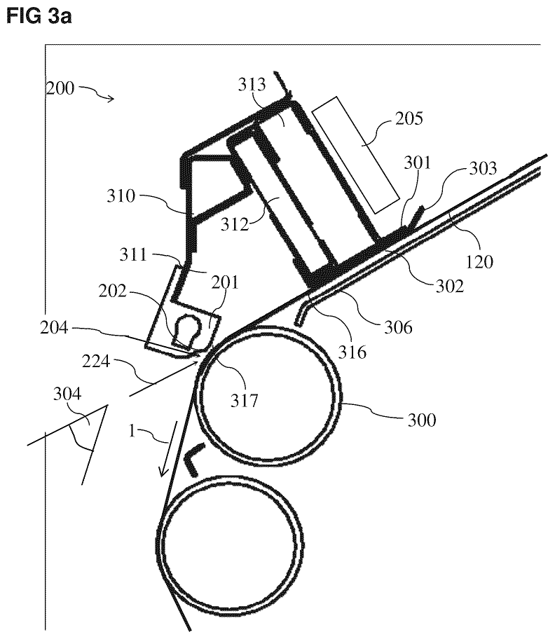

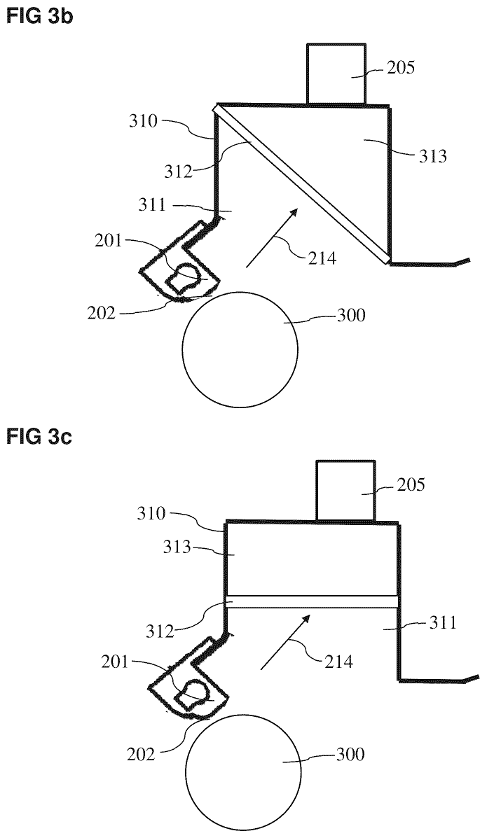

FIG. 3a shows an example of an extraction device 200 that has a roller 300, in particular a deflection roller, at the constriction 202. The roller 300 is an example of a guiding unit, in particular for a web-guiding unit, that is designed to guide the recording medium 120. The constriction 202, in particular the geometric properties of the constriction 202, can be particularly efficiently and precisely defined by the roller 300. A defined opening angle 304 of the exit 207 of the constriction 202 can also be efficiently established by the deflection of the recording medium 120 in order to form a funnel-like constriction 202 that tapers, starting from the exit 207 of the constriction 202, toward the intermediate point 212 of the constriction 202, and thus leads to an acceleration of the gas flow 204 within the constriction 202, which is advantageous for the blockading of the ink vapor 170 at the entrance 206 of the constriction 202.

The constriction 202 can be designed respectively funnel-shaped toward the exit 207 and toward the entrance 206 of the constriction 202. For example, this can be achieved in that the mechanical barrier 201 has a surface curving toward the recording medium 120. The surface of the mechanical barrier 201 can be circular or elliptical.

The extraction device 200 shown in FIG. 3a has a housing 310 that encloses an extraction chamber 311. The housing 310 is open toward the surface of the recording medium 120, so that the extraction chamber 311 is arranged directly above the surface of the recording medium 120 that is to be exhausted. The extraction chamber 311 has, relative to the transport direction 1 of the recording medium 120, a front side 316 at which the recording medium 120 is guided toward the extraction chamber 311, and a rear side 317 at which the recording medium 120 is guided away from the extraction chamber 311. The constriction 202 with the blockade gas flow 204 is arranged at the rear side 317 of the extraction chamber 311.

The extraction device 200 has, at the front side 316, a supply tunnel 302 through which the recording medium 120 is guided toward the extraction chamber 311. The tunnel 302 is formed by a front wall 301 and by a rearward wall 306 that are arranged essentially parallel to one another. The front wall 301 is arranged at the top side of the recording medium 120, and the rearward wall 306 is arranged at the rear side of the recording medium 120. The tunnel 302 can have a length along the transport direction 1 of 1 cm or more, in particular of 2 cm or more. The tunnel 302 enables the ink vapor 170 adhering to the surface of the recording medium 120 to be reliably guided to the extraction chamber 311.

The front wall 301 can have at the input side, relative to the transport direction 1, a segment 303 in which the front wall 301 is aligned at an angle away from the surface of the recording medium 120, so that a funnel forms via which the ink vapor 170 entrained with the recording medium 120 is guided into the tunnel 302.

The gas mixture 214 made up of the blockade gas flow 214 and the ink vapor 170 can be exhausted by the extraction unit 205 from the extraction chamber 311. The gas mixture 214 is thereby preferably exhausted across a filter unit 312 that is designed to filter particles out of the gas mixture 214. The filter unit 312 can have one or more filter layers, for example a prefilter (for relatively coarse particles) and one or more primary filters (for relatively fine particles). An air chamber 313 can be arranged downstream with respect to the filter unit 312, in particular between the filter unit 312 and the extraction unit 205.

FIGS. 3b and 3c show examples of configurations of the filter unit 312 within the housing 310 of the extraction device 200. In the example shown in FIG. 3b, the filter unit 312 is arranged essentially orthogonal to the flow direction of the exhausted gas mixture 214. This enables the provisioning of a filter unit 312 having a relatively large area, which is advantageous to the service life of the filter unit 312 and/or the operating duration of the extraction device 200. In the example shown in FIG. 3c, the filter unit 312 is arranged at an angle to the flow direction of the exhausted gas mixture 214, which can be advantageous to the required installation space of the extraction device 200. A particularly simple swapping of the filter unit 312 can thus also be enabled.

The extraction air flow produced by the extraction unit 205 preferably has a volumetric flow that is greater than the sum of the volumetric flow of the blockade gas flow 204 and the volumetric flow of a bypass air flow. For example, the bypass air flow can be produced by the tunnel 302 and/or on the transverse sides of the extraction device 200 that are transverse to the transport direction 1. A bypass air flow 224 can also be produced that travels from the exit 207, through the constriction 202, to the entrance 206, for example as is presented in conjunction with FIG. 2b. The gas mixture 214 can be reliably conveyed out of the extraction chamber 311 via the use of a relatively strong extraction air flow.

The filter unit 312 can be designed as a cartridge that can be simply exchanged.

As is shown in FIG. 3a, for example, the air gap 202 for blockading the ink vapor 170 can be arranged directly on the opposite side of a roller 300, in particular of a transport roller for the recording medium 120, so that a stable and defined clearance of the constriction 202 is produced. The gap width of the constriction 202 can also be flexibly adapted to different thicknesses of recording medium 120 by using a roller 300.

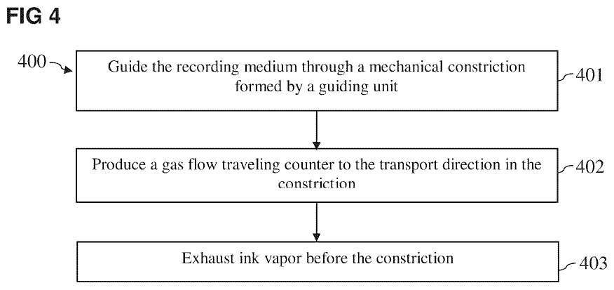

FIG. 4 shows a workflow diagram of a method 400 for exhausting ink vapor 170, generally aerosol, in an inkjet printing device 100. The printing device 100 comprises a print group 140 for printing to the front side of a recording medium 120 moved through the print group 140 along a transport direction 1.

The method 400 comprises the guiding 401 of the recording medium 120 along the transport direction 1, through a constriction 202 arranged above the front side or the top side of the recording medium 120. The constriction 202 can thereby have a height of 2-6 mm. The constriction 202 can be designed to limit the layer with ink vapor 170, said layer being entrained with the recording medium 120 on the front side of said recording medium 120, to a defined layer thickness via a mechanical and/or structural blockade. The layer thickness can thereby correspond to the height of the constriction 202.

A guiding unit 300 is preferably arranged at the constriction 202, wherein the recording medium 120 can be directed past the constriction 202 via the guiding unit 300. The guiding unit 300 can act on the back side of the recording medium 120 at the constriction 202, in particular at the narrowest intermediate point 212 of the constriction 202. The guiding unit 300 is preferably a rod or a roller.

Furthermore, the method 400 comprises producing 402 a gas flow 204, in particular an air flow, that travels counter to the transport direction 1 above the printed front side of the recording medium 120 in the constriction 202. The gas flow 204 can be particularly efficiently produced by a blower 203 arranged after the constriction 202, relative to the transport direction 1. The gas flow 204 can be designed to further reduce the effective layer thickness of the layer with ink vapor 170 on the front side of the recording medium 120, in particular to reduce it by 50% or more or by 80% or more.

The method 400 also comprises the exhausting 403 of ink vapor 170, generally of aerosol, from the printed front side of the recording medium 120 in an extraction region that is arranged before the constriction 202, relative to the transport direction 1. The ink vapor 170 can be exhausted by an extraction unit 205 that is arranged before the constriction 202. The combined use of a mechanical constriction 202 with an opposite gas flow 204 within the constriction 202 enables an efficient and comprehensive exhausting of the ink vapor 170 in the extraction region before the constriction 202.

An extraction device 200 for exhausting aerosol, in particular ink vapor, 170 in an inkjet printing device 100 is thus described in this document. As described in conjunction with FIG. 1a, for example, the printing device 100 can comprise a print group 140 for printing to the front side of a recording medium 120 moved through the print group 140 along a transport direction 1. The print group 140 can have one or more print bars 102 and/or print heads 103 that are designed to apply ink droplets onto the front side of the recording medium 120.

Within the scope of the printing process, ink vapor 170 can be generated in the print group 140, which ink vapor 170 is entrained, by the recording medium 120 moving in the transport direction 1, in an ink vapor layer on the front side of said recording medium 120.

The extraction device 200 comprises a mechanical barrier 201 that is designed to form a structural constriction 202 above the front side of the recording medium 120 directed past the mechanical barrier 201 in the transport direction 1, said front side having been printed to in the print group 140. The constriction 202 can, for example, be formed by a structural element, for instance by a plate, that is arranged above the front side of the recording medium 120.

The constriction 202 formed by the mechanical barrier 201 can have a length along the transport direction 1 of less than 25 mm, preferably less than 10 mm, even more preferably less than 5 mm. Swirls 211 can thus be generated at the entrance 206 of the constriction 202, via which the aerosol 170 can be advantageously detached from the front side of the recording medium 120.

The printing device 100 typically has a defined print width transverse to the transport direction 1, across which print width the front side of the recording medium 120 is printed to in the print group 140. The constriction 202 formed by the mechanical barrier 201 preferably extends over the entire print width of the printing device 100. The ink vapor 170 generated in the print group 140 can thus be especially comprehensively blocked and exhausted.

The constriction 202 is preferably formed by the mechanical barrier 201 at the front side of the recording medium 120 and by a guiding unit 300, in particular a transport roller, wherein the guiding unit 300 is designed to act on the back side of the recording medium 120 at the constriction 202, in particular at the (narrowest) intermediate point 212 of the constriction 202. The constriction 202 can be formed especially precisely, flexibly, and reliably via the use of a guide unit 300. This is so in particular given use of a rod or a roller as a guiding unit 300.

The guiding unit 300 can be designed to deflect the recording medium 120 at the constriction 202 so that, following the constriction 202, the clearance of the front side of the recording medium 120 from the mechanical barrier 201 increases, in particular increases seamlessly or continuously. Alternatively or additionally, the guiding unit 300 can be designed to deflect the recording medium 120 at the constriction 202 so that the constriction 202 has an opening angle 304 that is the same as or greater than a defined minimum angle, said opening angle 304 being toward the exit 207 of the constriction 202 that faces toward the blower 203 of the extraction device 200. The minimum opening angle can be 20° or more or 40° or more, for example.

Via the guiding unit 300, it can thus be efficiently effected that the constriction 202 forms a funnel opening toward the exit 207 of the constriction 202, via which the blockade gas flow 204 can be particularly reliably conveyed toward the constriction 202, in particular toward the (narrowest) intermediate point 212 of the constriction 202.

The guiding unit 300 can be adjustable such that the clearance between the mechanical barrier 201 and the guiding unit 300 can be varied in order to be able to adapt the constriction 202 to different thicknesses of recording medium 120. For this purpose, the axis of the guiding unit 300 can be adjustable so that the guiding unit 300 can be moved toward and/or away from the mechanical barrier 201, and so that the guiding unit 300 can be fixed at different distances from the mechanical barrier 201. A particularly flexible adaptation of the extraction device 200 to different recording media 120 can thus be effected.

The extraction device 200 also comprises a blower 203 that is designed to effect a blockade gas flow 204, for example pressurized or compressed air, traveling counter to the transport direction 1 above the printed front side of the recording medium 120 in the constriction 202. The blower 203, in particular what is known as an air knife, can be arranged at the exit of the constriction 202 relative to the transport direction 1, and can be designed to produce a gas flow 204, in particular an air flow, that travels from the exit 207 of the constriction 202 in the direction of the entrance 206 of the constriction 202. The gas flow 204 produced by the blower 203 can thereby be designed to push ink vapor 170 (i.e. generally aerosol) that is entrained by the front side of the recording medium 120 in the transport direction 1, from the entrance 206 of the constriction 202 in the direction of the exit 207 of the constriction 202, back in the direction toward the entrance 206 of the constriction 202. It can thus be reliably effected that ink vapor 170 is blocked at the mechanical barrier 201, and thus cannot arrive in a component 150 of the printing device 100 that is downstream of the extraction device 200.

The gas flow 204 produced by the blower 203 can in particular be designed such that the ink vapor 170 in the extraction region before the constriction 202, in particular directly at the front side the of the recording medium 120, has a movement velocity in the transport direction 1 that is less than the transport velocity of the recording medium 120, in particular is less by a factor of 2 or more. Via the gas flow 204 it can thus be effected that the ink vapor layer at the front side of the recording medium 120, before the entrance of the constriction 202, is slowed in order to reliably reduce the quantity of ink vapor 170 that passes through the constriction 202.

Alternatively or additionally, the gas flow 204 produced by the blower 203 can be designed to reduce the effective cross section area of the constriction 202 orthogonal to the front side of the recording medium 120, through which cross section area ink vapor 170 can flow through the constriction 202, relative to the actual cross section area of the constriction 202, in particular to reduce it by 50% or more or by 80% or more. The gas flow 204 thus enables a relatively high constriction 202 to be used in order to reliably avoid a collision between the recording medium 120 and the mechanical barrier 201, and to nevertheless produce a reliable separation of the ink vapor 170.

Overall, the extraction device 200 can be designed to have the effect that at most 10% of the ink vapor 170 guided from the recording medium 120 to the entrance 206 of the constriction 202 exits from the exit 207 of the constriction 202. This can be reliably effected via the combination of a mechanical and/or structural constriction 202 and a counter-flowing gas flow 204 that, if applicable, is additionally intensified by a bypass air flow 224.

The extraction device 200 also comprises an extraction unit 205 that is configured to exhaust ink vapor 170 (generally aerosol) from the printed front side of the recording medium 120 in the extraction region, which is arranged before the constriction 202 relative to the transport direction 1.

The extraction device 200 can comprise a housing 310 by which is formed an extraction region designed as an extraction chamber 311. The extraction chamber 311 can be open on the side facing toward the front side of the recording medium 120, so that the extraction chamber 311 is covered by the recording medium 120 on this side. The open side facing toward the front side of the recording medium 120 can be considered to be a suction opening. The suction opening can widen toward the front side of the recording medium 120 and/or can taper with increasing distance from the front side of the recording medium 120. A particularly efficient and comprehensive extraction of the ink vapor 170 can thus be effected in the extraction region before the constriction 202.

The extraction chamber 311 can have a front side 316 at which the recording medium 120 is guided to the extraction chamber 311, in particular into the extraction chamber 311. Furthermore, the extraction chamber 311 can have a back side 317 at which the recording medium 120 is guided away from the extraction chamber 311, in particular out of the extraction chamber 311. The constriction 202 is preferably arranged on the back side 317 of the extraction chamber 311 so that it can be reliably effected that the ink vapor 170 is retained in the extraction chamber 311.

The extraction device 200 can have an infeed tunnel 302 that extends, starting from the front side 316 of the extraction chamber 311, counter to the transport direction 1 (away from the extraction chamber 311) so that the recording medium 120 is guided through the infeed tunnel 302 to the extraction chamber 311, in particular into the extraction chamber 311. The infeed tunnel 302 can have a forward tunnel wall 301 that is arranged at the front side of the recording medium 120 and a rearward tunnel wall 306 that is arranged at the rear side of the recording medium 120. The forward tunnel wall 301 thereby preferably has, at the end facing away from the extraction chamber 311, a segment 303 (for example a ramp) traveling away from the front side of the recording medium 120, by which segment 303 a funnel is formed to capture aerosol 170 (in particular ink vapor) that is arranged at the front side of the recording medium 120. By providing an infeed tunnel 302 at the front side 316 of the extraction chamber 311, it can be particularly reliably effected that the ink vapor 170 is guided as completely as possible into the extraction chamber 311 (and can be exhausted from there).

The extraction unit 205, in particular the blower of the extraction unit 205, can be designed to convey, in particular to exhaust, the gas mixture 214 (with ink vapor 170) arranged in the extraction chamber 311 out of said extraction chamber 311. The extraction chamber 200 thereby preferably has a filter unit 312 arranged between the extraction chamber 311 and the extraction unit 205.

The filter unit 312 can be aligned essentially orthogonal to the flow direction of the gas mixture 214. Alternatively or additionally, the filter unit 312 can have a plurality of filter layers, in particular at least one coarse filter layer and at least one fine filter layer following in the flow direction. Alternatively or additionally, the filter unit 312 can be designed as a replaceable cartridge. An especially reliable and efficient filtering of the gas mixture 214 can thus be effected.

An extraction device 200 for an inkjet printing device 100 is thus described that is designed to guide a printed recording medium 120 along a transport direction 1 through a mechanical constriction 202 with a counter-directed gas flow 204, in order to be able to efficiently and comprehensively exhaust ink vapor 170 in the transport direction 1 before the constriction 202.

Furthermore, in this document a printing device 100 is described that comprises the extraction device 200 described in this document.

Ink vapor 170 generated in a print group 140 can be reliably remedied via the measures described in this document, in particular in order to avoid a fouling of downstream components such as a drying unit 150.

### REFERENCE LIST

1 transport direction
21, 22 nozzle
31, 32 column (of the print image)
100 printing device
101 control unit
102 print bar
103 print head
120 recording medium
140 print group
150 fixing or drying unit
155 housing (drying unit)
170 aerosol (ink vapor)
200 extraction device
201 mechanical barrier
202 nip/constriction/blockade point
203 blower
204 gas flow
205 extraction unit
206 entrance of the constriction
207 exit of the constriction
211 swirl
212 intermediate point of the constriction
213 housing
214 exhausted gas mixture
223 channel (within the mechanical barrier)
224 bypass gas flow
300 guiding unit, in particular roller or rod, at the constriction
301 forward tunnel wall
302 infeed tunnel
303 inclined segment of the forward tunnel wall
304 opening angle
306 rearward tunnel wall
310 housing (extraction device)
311 extraction chamber
312 filter unit
313 air chamber
316 front side of the extraction chamber
317 back side of the extraction chamber
400 method for exhausting aerosol
401-403 method steps

1. An extraction device to exhaust aerosol in an inkjet printing device, the printing device comprising a print group for printing to a front side of a recording medium moved through the print group along a transport direction, the extraction device comprising:
a mechanical barrier and a guiding unit together configured to form a constriction above the front side, printed to in the print group, of the recording medium directed past the mechanical barrier in the transport direction; wherein the guiding unit is configured to act on the back side of the recording medium at the constriction;
a blower that is configured to produce a gas flow traveling counter to the transport direction above the printed front side of the recording medium in the constriction; and
an extraction unit that is configured to exhaust aerosol from the printed front side of the recording medium in an extraction region that is arranged before the constriction with respect to the transport direction.

2. The extraction device according to claim 1, wherein the guiding unit is further configured to deflect the recording medium at the constriction so that at least one of:
a clearance of the front side of the recording medium from the mechanical barrier increases following the constriction; or
the constriction has an opening angle toward an exit of the constriction facing toward the blower, which opening angle is equal to or greater than a minimum angle.

3. The extraction device according claim 1, wherein the guiding unit is adjustable such that a clearance between the mechanical barrier and the guiding unit is variable in order to adapt the constriction to different thicknesses of recording medium.

4. The extraction device according to claim 1, wherein
the extraction device comprises a housing by which is formed the extraction region designed as an extraction chamber; and
the extraction chamber is open at a side facing toward the front side of the recording medium, so that the extraction chamber is covered by the recording medium on the side facing toward the front side of the recording medium.

5. The extraction device according to claim 4, wherein
the extraction chamber has a front side at which the recording medium is guided toward the extraction chamber;
the extraction chamber has a back side at which the recording medium is guided away from the extraction chamber; and
the constriction is arranged on the back side of the extraction chamber.

6. The extraction device according to claim 5, further comprising:
an infeed tunnel that extends counter to the transport direction, starting from the front side of the extraction chamber, so that the recording medium is guided through the infeed tunnel to the extraction chamber, wherein
the infeed tunnel has a front tunnel wall that is arranged at the front side of the recording medium and a rearward tunnel wall that is arranged at the back side of the recording medium.

7. The extraction device according to claim 6, wherein the front tunnel wall has, at an end facing away from the extraction chamber, a segment traveling at an angle away from the front side of the recording medium, by which segment is formed a funnel to capture aerosol that is arranged at the front side of the recording medium.

8. The extraction device according to claim 4, wherein
the extraction unit is designed to convey a gas mixture arranged in the extraction chamber out of the extraction chamber; and
the extraction device has a filter unit arranged between the extraction chamber and the extraction unit.

9. The extraction device according to claim 8, wherein
the filter unit is aligned essentially orthogonal to a flow direction of the gas mixture.

10. The extraction device according to claim 8, wherein
the filter unit has a plurality of filter layers.

11. The extraction device according to claim 10, wherein the plurality of layers comprise a coarse filter layer and a fine filter layer following in the flow direction.

12. The extraction device according to claim 8, wherein
the filter unit is designed as a replaceable cartridge.

13. A method for exhausting aerosol in an inkjet printing device, the printing device comprising a print group for printing to a front side of a recording medium moved through the print group along a transport direction, the method comprising
guiding the recording medium along the transport direction through a constriction arranged above the front side of the recording medium; wherein the constriction is formed by a guiding unit that acts on a back side of the recording medium at the constriction;
producing a gas flow that, in the constriction, travels counter to the transport direction above the printed front side of the recording medium; and
exhausting aerosol from the printed front side of the recording medium in an extraction region that is arranged before the constriction, with respect to the transport direction.

14. The method according to claim 13, wherein the guiding unit is further configured to deflect the recording medium at the constriction, the method further comprising deflecting the recording medium so that a clearance of the front side of the recording medium from a mechanical barrier increases following the constriction.

15. The method according claim 13, further comprising:
adjusting the guiding unit such that a clearance between a mechanical barrier and the guiding unit is variable in order to adapt the constriction to different thicknesses of recording medium.
